(19) United States
(12) Patent Application Publication
(10) Pub. No.: US 2025/0128682 A1
(43) Pub. Date: Apr. 24, 2025

(54) VEHICLE CONTROL DEVICE, VEHICLE CONTROL METHOD, AND VEHICLE CONTROL PROGRAM

(71) Applicant: TOYOTA JIDOSHA KABUSHIKI KAISHA, Toyota-shi (JP)

(72) Inventor: Kazuya SAIMURA, Suntou-gun (JP)

(73) Assignee: TOYOTA JIDOSHA KABUSHIKI KAISHA, Toyota-shi (JP)

(21) Appl. No.: 18/906,661

(22) Filed: Oct. 4, 2024

(30) Foreign Application Priority Data
Oct. 24, 2023 (JP) 2023-182657

(51) Int. Cl. B60T 7/22

(52) U.S. Cl. CPC B60T 7/22; B60T 2210/32

(57) ABSTRACT

The vehicle control device 1 comprises a sensor that acquires information regarding the own vehicle and information regarding objects located around the own vehicle, and a processor capable of executing a risk reduction process to control the own vehicle so that the risk of contact between the own vehicle and another vehicle is reduced based on the information acquired from the sensor. The processor is configured to restrict the execution of the risk reduction process under specific circumstances in which, based on the information acquired from the sensor, another vehicle is traveling in a second lane adjacent to the first lane of the own vehicle, an obstacle is detected in front of the other vehicle in the second lane, and the lateral velocity of the other vehicle, which is moving toward the first lane as it approaches the obstacle, is decreasing.

### BACKGROUND OF THE INVENTION

The present invention relates to a vehicle control device, vehicle control method, and vehicle control program equipped with a function to reduce the risk of contact between an own vehicle and another vehicle.

### DESCRIPTION OF THE RELATED ART

A vehicle control device equipped with a function to reduce the risk of contact between an own vehicle and another vehicle has been proposed (for example, refer to Patent Document 1 below). This vehicle control device (hereinafter referred to as “conventional device”) acquires the trajectory (predicted trajectory) of the own vehicle and the trajectory (predicted trajectory) of an oncoming vehicle. The conventional device determines that there is a high risk of contact between the own vehicle and the oncoming vehicle when their predicted trajectories intersect, and executes a process (risk reduction process) to reduce the risk.
Patent Document 1: JP 2020-142665 A

### SUMMARY

Meanwhile, a scenario is assumed where another vehicle is traveling in a second lane adjacent to the first lane in which the own vehicle is traveling, and the other vehicle moves towards the first lane to avoid an obstacle. In this scenario, the other vehicle may temporarily enter the first lane. Also, for example, if the obstacle is relatively small and biased towards the side opposite the first lane, the other vehicle may be able to avoid the obstacle by moving laterally within the second lane without entering the first lane. In this way, the driver of the other vehicle is likely to steer so that the vehicle follows the shortest possible avoidance path.

The conventional device sequentially acquires the position of the other vehicle. Based on the changes in the acquired position of the other vehicle, the conventional device acquires the predicted trajectory of the other vehicle. In the aforementioned scenario, when the other vehicle starts avoiding the obstacle, it gradually approaches the first lane. Therefore, the conventional device predicts that “the other vehicle will continue to proceed towards the first lane and enter the first lane.” If the own vehicle is traveling along the first lane, the conventional device determines that the predicted trajectories of the own vehicle and the other vehicle will intersect, and begins the risk reduction process. In other words, the conventional device initiates the risk reduction process as soon as the other vehicle starts avoiding the obstacle.

However, as mentioned above, in this scenario, even if the other vehicle (or part of the other vehicle) enters the first lane, the time the other vehicle (or part of it) stays within the first lane is short. Additionally, there are cases where the other vehicle can avoid the obstacle by merely moving laterally within the second lane. In other words, in this scenario, the other vehicle only temporarily moves towards the first lane to avoid the obstacle, and after passing the obstacle, it is highly likely that the other vehicle will quickly move towards the center of the width of the second lane (away from the first lane), reducing the possibility of contact between the own vehicle and the other vehicle. Nevertheless, the conventional device starts the risk reduction process from the moment the other vehicle begins avoiding the obstacle, which may cause the driver of the own vehicle to find the process bothersome.

One of the objectives of the present invention is to provide a vehicle control device that can restrict the execution of unnecessary risk reduction processes.

To solve the above problem, the vehicle control device (1) of the present invention comprises:
a sensor (20) that acquires information (v0) regarding the own vehicle (V0) and information (PR, vr) regarding objects (OB, V1κ) located around the own vehicle; and
a processor (10) that is capable of executing a risk reduction process to control the own vehicle so that the risk of contact between the own vehicle and another vehicle is reduced based on the information acquired from the sensor.
   The processor is configured to restrict the execution of the risk reduction process under specific circumstances in which, based on the information acquired from the sensor, the other vehicle is traveling in a second lane adjacent to a first lane that is the lane of the own vehicle, an obstacle located in front of the other vehicle in the second lane is detected, and the lateral velocity of the other vehicle, which is moving towards the first lane as it approaches the obstacle, from the second lane towards the first lane is decreasing.

The vehicle control method according to the present invention includes:
an information acquisition step of acquiring information regarding the own vehicle and information regarding objects located around the own vehicle; and
a risk reduction step of executing a risk reduction process to control the own vehicle so that the risk of contact between the own vehicle and another vehicle is reduced based on the information acquired in the information acquisition step. The risk reduction step includes a process to restrict the execution of the risk reduction process under specific circumstances in which, based on the information acquired from the sensor, the other vehicle is traveling in a second lane adjacent to a first lane that is the lane of the own vehicle, an obstacle located in front of the other vehicle in the second lane is detected, and the lateral velocity of the other vehicle, which is moving towards the first lane as it approaches the obstacle, from the second lane towards the first lane is decreasing.

The vehicle control program according to the present invention causes a computer in the own vehicle to execute:
an information acquisition step of acquiring information regarding the own vehicle and information regarding objects located around the own vehicle; and
a risk reduction step of executing a risk reduction process to control the own vehicle so that the risk of contact between the own vehicle and another vehicle is reduced based on the information acquired in the information acquisition step. The risk reduction step includes a process to restrict the execution of the risk reduction process under specific circumstances in which, based on the information acquired from the sensor, the other vehicle is traveling in a second lane adjacent to a first lane that is the lane of the own vehicle, an obstacle located in front of the other vehicle in the second lane is detected, and the lateral velocity of the other vehicle, which is moving towards the first lane as it approaches the obstacle, from the second lane towards the first lane is decreasing.

As described above, in a scenario where another vehicle traveling around the own vehicle is avoiding an obstacle, it is likely that the driver of the other vehicle will steer in a way that follows the shortest possible avoidance path. In such a case, the lateral velocity of the other vehicle is highly likely to change as follows:
the lateral velocity increases from the moment the other vehicle starts avoiding the obstacle, reaches its maximum before the other vehicle reaches the side of the obstacle, and then decreases as the vehicle proceeds towards the side of the obstacle. By the time the other vehicle reaches the side of the obstacle, its lateral velocity is minimal, and the vehicle will proceed towards the central part of the second lane's width immediately after passing the side of the obstacle. Therefore, the processor of the vehicle control device according to the present invention estimates that if an obstacle is present in front of the other vehicle in the second lane and the lateral velocity of the other vehicle (speed towards the first lane) is decreasing, the driver of the other vehicle intends to quickly return to the central part of the second lane after passing the side of the obstacle. In such a case, the possibility of contact between the own vehicle and the other vehicle is low. Consequently, in these special circumstances, the processor restricts (suppresses) the execution of the risk reduction process. That is, according to the vehicle control device of the present invention, the execution of unnecessary risk reduction processes is restricted.

In the vehicle control device according to one aspect of the present invention,
the processor executes, as the risk reduction process:
a process to acquire the predicted time to contact (TTCκ) between the own vehicle and the other vehicle based on the information acquired from the sensor; and
a process to control the own vehicle so that a driving operation to brake the own vehicle is assisted when the predicted time is below a threshold (TTCκ).

According to this, the own vehicle is braked through manual braking operations by the driver and/or automatic braking control by the processor, reducing the risk of contact between the own vehicle and the other vehicle.

In the vehicle control device according to another aspect of the present invention, the processor assigns a first value (Ta) to the threshold under circumstances excluding the specific circumstances, and assigns a second value (TB), smaller than the first value, to the threshold under the specific circumstances.

According to this, in circumstances excluding the specific circumstances (where the lateral velocity of the other vehicle is not decreasing), the risk reduction process is initiated when there is a relatively large time margin until the own vehicle and the other vehicle make contact (i.e., when the predicted time to contact (TTCκ) decreases and falls below a relatively large threshold (Ta), referred to as the “normal processing start point”). This ensures high safety. On the other hand, under the specific circumstances, the risk reduction process is not initiated at the normal processing start point, but rather when the predicted time decreases further and falls below a relatively small threshold (TB). In other words, under the specific circumstances, the timing of the risk reduction process is delayed compared to other situations, thus restricting the execution of the risk reduction process under the specific circumstances.

### BRIEF DESCRIPTION OF THE DRAWINGS

FIG. 1 is a block diagram of a vehicle control device according to one embodiment of the present invention.

FIG. 2 is a plan view showing a first scenario in which another vehicle (an oncoming vehicle) avoids an obstacle.

FIG. 3 is a plan view showing a second scenario in which another vehicle (a parallel vehicle) avoids an obstacle.

FIG. 4 is a graph showing the changes in lateral velocity when another vehicle avoids an obstacle and a graph showing the changes in the threshold used as a parameter to determine whether to initiate the braking assistance process.

FIG. 5 is a flowchart of the program executed by the CPU to implement the braking assistance function.

### DESCRIPTION OF THE EMBODIMENTS

### Overview

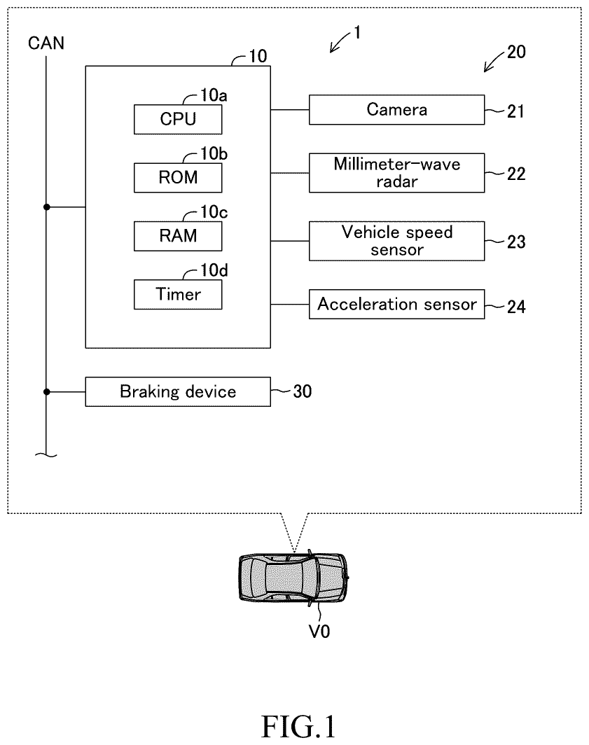

As shown in FIG. 1, the vehicle control device 1 according to one embodiment of the present invention is applied to a vehicle V0 (hereinafter referred to as “own vehicle”) equipped with an autonomous driving function. The vehicle control device 1 is capable of executing braking assistance control to brake the own vehicle to reduce the risk of contact between the own vehicle and another vehicle in a state where the autonomous driving function is deactivated, and the driver is manually operating the vehicle. Furthermore, the vehicle control device 1 has a function to restrict the execution of braking assistance control in scenarios where another vehicle traveling in an adjacent lane is avoiding an obstacle.

### (Specific Configuration)

As shown in FIG. 1, the vehicle control device 1 includes an ECU 10, in-vehicle sensors 20, and a braking device 30.

The ECU 10 is equipped with a microcomputer that includes a CPU 10a, ROM 10b (rewritable non-volatile memory), RAM 10c, and a timer 10d. The CPU executes various functions by running programs (instructions) stored in the ROM. The ECU 10 is connected to other ECUs via a Controller Area Network (CAN).

The in-vehicle sensors 20 include a camera 21, a millimeter-wave radar 22, a vehicle speed sensor 23, and an acceleration sensor 24.

The camera 21 includes an imaging device and an image processing device. The imaging device, for example, incorporates a CCD. The imaging device is installed at the front, right side, left side, and rear of the own vehicle and is directed toward the front, right, left, and rear of the vehicle, respectively. The imaging device captures the surrounding area of the own vehicle at a predetermined frame rate, obtaining image data. The image processing device acquires image data from the imaging device and analyzes it to recognize (identify) objects within the field of view. For example, the image processing device recognizes (identifies) lane markers (lane division lines), other vehicles (other vehicles located in lane L2 adjacent to the lane L1 in which the own vehicle is traveling, such as vehicles V1a, V1b, etc.), and obstacles. The image processing device provides the recognition results (object identification results) to the ECU 10.

The millimeter-wave radar 22 includes a transmission/reception unit and a signal processing unit (not shown). The transmission/reception unit emits millimeter waves (hereinafter referred to as “millimeter waves”) into the surrounding area of the own vehicle (regions diagonally in front and diagonally behind the vehicle) and receives the millimeter waves (reflected waves) that are reflected from objects (e.g., other vehicles V1a, V2a, etc.) located within these areas. The signal processing unit acquires various information regarding the reflection points of the millimeter waves based on the time from emission to reception, the attenuation level of the reflected waves, the difference between the frequency of the emitted millimeter waves and the received reflected waves, and other physical quantities. For example, the signal processing unit calculates the position (relative position PR in terms of direction and distance) of each reflection point relative to the transmission/reception unit. Additionally, the signal processing unit calculates the velocity vr (vector) of each reflection point relative to the own vehicle. The calculation results (data indicating the distribution of reflection points, including the position PR and velocity vr of each reflection point) are provided to the ECU 10.

The vehicle speed sensor 23 includes a rotation measurement circuit and a vehicle speed calculation device. The rotation measurement circuit consists of a pulse generation circuit that outputs a pulse (electrical signal) each time the wheels of the own vehicle rotate by a predetermined angle, and a counter circuit that counts the number of pulses. The vehicle speed calculation device obtains the output value (pulse count) from the counter circuit at regular intervals (at the end of each unit time) and resets the count to zero. In this way, the vehicle speed calculation device obtains the wheel rotation number N per unit time. By multiplying the rotation number N by a coefficient k, the vehicle speed calculation device calculates the vehicle speed vs (speed in the forward/reverse direction or longitudinal speed, as an absolute value) of the own vehicle. The vehicle speed calculation device provides the obtained vehicle speed vs to the ECU 10.

The acceleration sensor 24 includes a piezoelectric element. When the own vehicle accelerates (or decelerates) in the forward/reverse direction and/or lateral direction, the piezoelectric element deforms in the corresponding direction, causing the output voltage of the piezoelectric element to change. Based on the output of the piezoelectric element, the acceleration sensor 24 acquires the acceleration of the own vehicle in both the longitudinal and lateral directions. The acceleration sensor 24 provides these acceleration values to the ECU 10.

The braking device 30 applies braking force to the vehicle's wheels (brake discs). The braking device 30 includes a brake ECU and brake calipers. The brake ECU acquires information (target value) representing the target braking force from other ECUs (such as the ECU 10) and controls the brake calipers based on this information to match the braking force applied to the brake discs with the target value.

### (Braking Assistance Function)

The ECU 10, when the ignition switch is in the “on” state, periodically acquires various information from the vehicle speed sensor 23 and, based on this information, calculates the time TTCa, TTCb, . . . , until the own vehicle and other vehicles V1a, V1b, . . . (vehicles traveling in lane L2) make contact. Specifically, the ECU 10 calculates (estimates) the position and direction of travel of the own vehicle and the other vehicle V1κ (κ=a, b, . . . ) at each time T1, T2, . . . after the current time TO, based on the information obtained from the in-vehicle sensors 20. The ECU 10 calculates the time TTCκ from time T0 to time Tn if the predicted distance between the own vehicle and the other vehicle V1K at time Tn is below a threshold and the directions of travel of the own vehicle and the other vehicle are not parallel. The ECU 10 then compares the time TTCκ with a pre-set threshold TTCκth for each other vehicle V1K. When the time TTCκ (κ=a, b, . . . ) is below the threshold TTCκth, the ECU 10 executes a risk reduction process to reduce the risk of contact between the own vehicle and the other vehicle V1κ. Specifically, the ECU 10 executes braking assistance control to control the braking device 30 so that the own vehicle is braked. As described later, the ECU 10 determines the value assigned to the threshold TTCκth (Tα or Tβ) based on the behavior (lateral speed vyκ) of the other vehicle V1κ (V1a, V1b, . . . ).

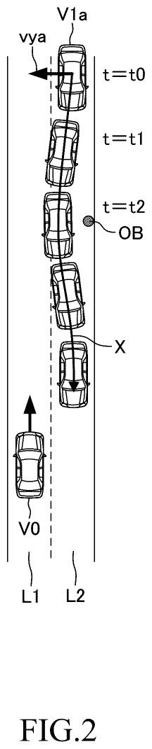

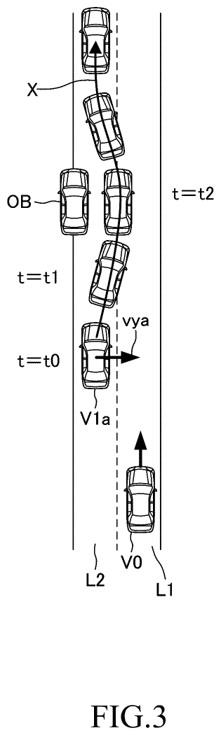

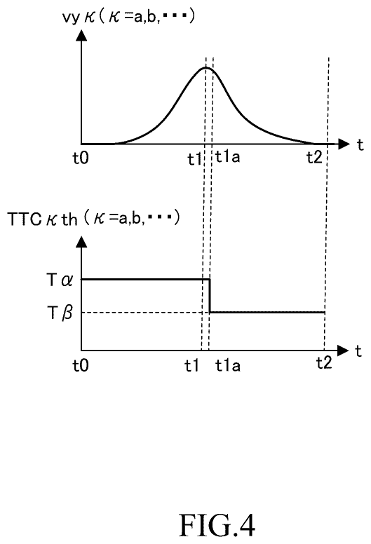

As shown in FIG. 2 or FIG. 3, for example, in a scenario where the driver of another vehicle V1a traveling around the own vehicle is executing a driving maneuver to avoid an obstacle OB (a stationary object or a very slow-moving vehicle) located in front of vehicle V1a (in its direction of travel), the driver is likely to steer so that the other vehicle V1a deviates as little as possible from lane L2 (or enters adjacent lane L1 as little as possible). In other words, the driver of vehicle V1a is likely to steer so that vehicle V1a follows the shortest possible avoidance course X. In this case, the lateral speed vya (the speed in the width direction of lane L2 towards lane L1) of vehicle V1a is likely to change as follows. As shown in FIG. 4, the lateral speed vya (κ=a) increases from time to when vehicle V1a begins avoiding the obstacle OB. The lateral speed vya reaches a maximum at time t1, before vehicle V1a reaches the side of obstacle OB, and then decreases as vehicle V1a moves towards the side of obstacle OB. By the time vehicle V1a reaches the side of obstacle OB at time t2, the lateral speed vya is minimal. Vehicle V1a then proceeds towards the center of the width of lane L2 immediately after passing the side of obstacle OB. Therefore, the ECU 10 of the vehicle control device 1 according to the present invention estimates that if obstacle OB is present in front of vehicle V1a in lane L2 and the lateral speed vya of vehicle V1a is decreasing, the driver of vehicle V1a intends to return quickly to the center of lane L2 after avoiding obstacle OB. In this case, even if the own vehicle continues traveling without decelerating around vehicle V1a in lane L2, the likelihood of contact between the own vehicle and vehicle V1a is low. Thus, in this situation, it is preferable to restrict (suppress) the execution of the risk reduction process (braking assistance control) intended to reduce the risk of contact between the own vehicle and vehicle V1a.

However, even if the likelihood of contact between the own vehicle and vehicle V1a is low, there may still be a high risk of contact between the own vehicle and other vehicles. For example, if the lateral speed vyb of another vehicle V1b (not shown) increases at time t1 as vehicle V1b approaches the side of obstacle OB, the driver of vehicle V1b may intend to cross into lane L1 or change lanes into lane L1. Therefore, in this situation, it is preferable not to restrict the execution of braking assistance control to reduce the risk of contact between the own vehicle and vehicle V1b.

Therefore, when the ECU 10 detects multiple other vehicles V1κ (V1a, V1b, . . . ), it determines for each of these vehicles V1κ (V1a, V1b, . . . ) whether to restrict the execution of the braking assistance control aimed at reducing the risk of contact with the own vehicle. Specifically, when there is an obstacle OB in front of another vehicle V1κ, the ECU 10 sequentially acquires the lateral velocity vyκ of each vehicle. That is, based on the information obtained from the in-vehicle sensors 20, the ECU 10 acquires and temporarily stores the lateral velocity vyκ[n] of each other vehicle V1κ and then, after a predetermined short time, acquires the lateral velocity vyκ[n+1] again. The ECU 10 then calculates the difference between the lateral velocities vyκ [n+1] and vyκ [n] (i.e., the change amount Δvyκ=vyκ[n+1]−vyκ[n]).

Based on the change amount Δvyκ, if the lateral velocity vyκ is increasing (Δvyκ>0), the ECU 10 estimates that “the other vehicle V1κ may continue to move toward lane L1 after passing the side of the obstacle OB.” Therefore, in this case, the braking assistance control to reduce the risk of contact between the own vehicle and the other vehicle V1κ is not restricted. Specifically, the ECU 10 assigns a relatively long time Tα to the threshold TTCκth. As a result, the ECU 10 initiates the risk reduction process from the point when the time TTCκ decreases and falls below a relatively large threshold (Tα), which is referred to as the “normal processing start point.” In other words, the ECU 10 is configured to start braking assistance control when there is a relatively large time margin before the own vehicle comes into contact with the other vehicle V1κ.

On the other hand, if the lateral velocity vyκ is decreasing (Δvyκ<0), the ECU 10 estimates that “the other vehicle V1κ is likely to quickly return to the center of lane L2 after passing the side of obstacle OB.” In this case, the ECU 10 assigns a relatively short time Tβ (<Tα) to the threshold TTCκth. As a result, braking assistance control is not initiated at the normal processing start point (when the time TTCκ reaches the relatively large threshold Ta), but rather when the time TTCκ decreases further and falls below the relatively small threshold TB. In other words, under the specific circumstances where an obstacle OB is in front of the other vehicle V1κ and the lateral velocity vyκ is decreasing, the start timing of the risk reduction process is delayed compared to other situations. That is, under these specific circumstances, the execution of braking assistance control is restricted (suppressed).

If the lateral velocity vyκ remains constant, the ECU 10 maintains the value assigned to the threshold TTCκth. Additionally, if there is no obstacle OB in front of the other vehicle V1κ, the ECU 10 assigns the time Tα to the threshold TTCκth.

For example, in the scenario illustrated in FIG. 4, the lateral velocity vyκ increases from time to and reaches its maximum at time t1. After time t1, the lateral velocity vyκ decreases. In this case, the ECU 10 first detects the decrease in lateral velocity vyκ at time t1a (t1+Δt). The ECU 10 continues to detect the decrease in lateral velocity vyκ during each processing timing from time t1a to time t2. Therefore, in this example, a relatively long time Tα is assigned to the threshold TTCκth from time t0 to time t1a, and a relatively short time TB is assigned to the threshold TTCκth from time t1a to time t2.

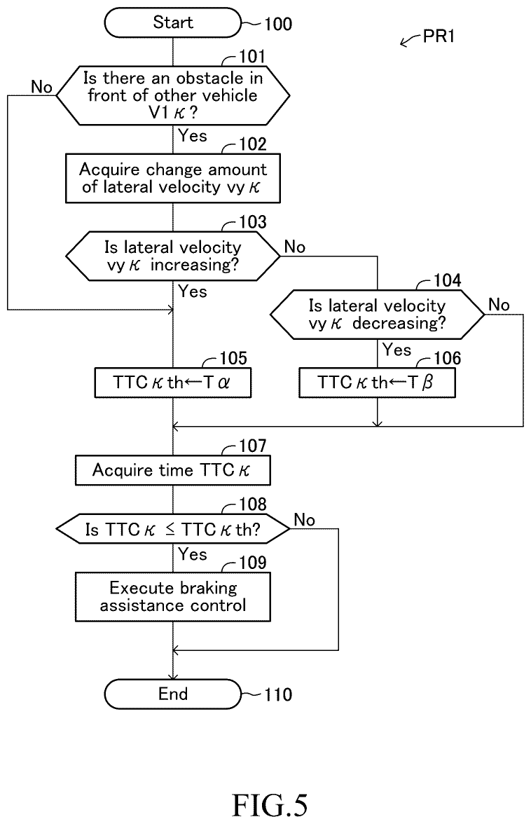

Next, with reference to FIG. 5, the program PR1 executed by the CPU 10a (hereinafter referred to simply as “CPU”) to implement the braking assistance function described above will be explained. The CPU starts executing program PR1 when it detects that another vehicle V1κ is traveling in lane L2 based on information obtained from the in-vehicle sensors 20. If the CPU detects multiple other vehicles V1κ (κ=a, b, . . . ), it executes program PR1 for each of the other vehicles V1κ.

### (Program PR1)

The CPU starts executing program PR1 from step 100 and proceeds to step 101.

In step 101, the CPU determines whether an obstacle OB is present in front of the other vehicle V1κ (in the direction of travel). If the CPU determines that an obstacle OB is present in front of the other vehicle V1κ (101: Yes), the process proceeds to step 102. If the CPU determines that no obstacle OB is present in front of the other vehicle V1κ (101: No), the process moves to step 105, which will be described later.

In step 102, the CPU acquires the change amount Δvyκ of the lateral velocity vyκ per unit time for the other vehicle V1κ. The process then proceeds to step 103.

In step 103, the CPU determines whether the lateral velocity vyκ is increasing based on the change amount Δvyκ. If the CPU determines that the lateral velocity vyκ is increasing (Δvyκ>0) (103: Yes), the process proceeds to step 105, which will be described later. If the CPU determines that the lateral velocity vyκ is not increasing (Δvyκ≤0) (103: No), the process proceeds to step 106, which will be described later.

In step 104, the CPU determines whether the lateral velocity vyκ is decreasing based on the change amount Δvyκ. If the CPU determines that the lateral velocity vyκ is decreasing (Δvyκ<0) (104: Yes), the process proceeds to step 106. If the CPU determines that the lateral velocity vyκ is not decreasing (Δvyκ≥0) (104: No), the process moves to step 107, which will be described later.

In step 105, the CPU assigns a relatively long time Tα to the threshold TTCκth. The process then proceeds to step 107.

In step 106, the CPU assigns a relatively short time TB to the threshold TTCκth. The process then proceeds to step 107.

In step 107, the CPU acquires the time TTCκ until the own vehicle contacts the other vehicle V1κ. The process then proceeds to step 108.

In step 108, the CPU determines whether the time TTCκ is below the threshold TTCκth. If the CPU determines that the time TTCκ is below the threshold TTCκth (107: Yes), the process proceeds to step 109. If the CPU determines that the time TTCκ is not below the threshold TTCκth (107: No), the process moves to step 110, where the execution of program PR1 ends.

In step 109, the CPU executes the braking assistance control. The process then proceeds to step 110, where the execution of program PR1 ends.

### (Effect)

When an obstacle OB is present in front of the other vehicle V1κ in lane L2 and the lateral velocity vyκ of the other vehicle V1κ is decreasing, it is likely that the driver of the other vehicle V1κ intends to quickly return to the center of lane L2 after passing the side of the obstacle OB. In this case, even if the own vehicle continues to drive without decelerating while traveling around the other vehicle V1κ in lane L1, the possibility of contact between the own vehicle and the other vehicle V1κ is low. Therefore, in this situation, the ECU 10 restricts (suppresses) the execution of the braking assistance control. In other words, according to the vehicle control device 1, unnecessary risk reduction processes are restricted from being executed.

The present invention is not limited to the above embodiment and can adopt various modifications within the scope of the invention as described below.

### <Modification 1>

The ECU 10 may execute a notification process, in which an image display device, acoustic device, or other means is controlled to notify the driver of the own vehicle that there is a risk of contact between the own vehicle and another vehicle, instead of or in addition to the braking assistance process as part of the risk reduction process.

### <Modification 2>

Even if there is an obstacle in front of the other vehicle V1κ and the lateral velocity vyκ is decreasing, the ECU 10 may assign a relatively long time Tα to the threshold TTCκth if it detects that the other vehicle V1κ has activated (is flashing) the turn signal in the direction of lane L1.

What is claimed is:

1. A vehicle control device comprising:
a sensor that acquires information regarding an own vehicle and information regarding objects located around the own vehicle; and
a processor that is capable of executing a risk reduction process to control the own vehicle so that the risk of contact between the own vehicle and another vehicle is reduced based on the information acquired from the sensor,
wherein the processor is configured to restrict the execution of the risk reduction process under specific circumstances in which, based on the information acquired from the sensor, the other vehicle is traveling in a second lane adjacent to a first lane that is the lane of the own vehicle, an obstacle located in front of the other vehicle in the second lane is detected, and the lateral velocity of the other vehicle, which is moving towards the first lane as it approaches the obstacle, from the second lane towards the first lane is decreasing.

2. A vehicle control device according to claim 1,
wherein the processor, as the risk reduction process, executes:
a process to acquire a predicted time until contact between the own vehicle and the other vehicle based on the information acquired from the sensor; and
a process to control the own vehicle so that a driving operation to brake the own vehicle is assisted when the predicted time is below a threshold value.

3. A vehicle control device according to claim 2,
wherein the processor assigns a first value to the threshold value under circumstances excluding the specific circumstances, and assigns a second value, smaller than the first value, to the threshold value under the specific circumstances.

4. A vehicle control method including:
an information acquisition step of acquiring information regarding an own vehicle and information regarding objects located around the own vehicle; and
a risk reduction step of executing a risk reduction process to control the own vehicle so that the risk of contact between the own vehicle and another vehicle is reduced based on the information acquired in the information acquisition step,
wherein the risk reduction step includes a process of restricting the execution of the risk reduction process under specific circumstances in which, based on the information acquired from the sensor, the other vehicle is traveling in a second lane adjacent to a first lane that is the lane of the own vehicle, an obstacle located in front of the other vehicle in the second lane is detected, and the lateral velocity of the other vehicle, which is moving towards the first lane as it approaches the obstacle, from the second lane towards the first lane is decreasing.

5. A non-transitory storage medium storing a vehicle control program for causing a computer equipped in the own vehicle to execute:
an information acquisition step of acquiring information regarding an own vehicle and information regarding objects located around the own vehicle; and
a risk reduction step of executing a risk reduction process to control the own vehicle so that the risk of contact between the own vehicle and another vehicle is reduced based on the information acquired in the information acquisition step,
wherein the risk reduction step includes a process of restricting the execution of the risk reduction process under specific circumstances in which, based on the information acquired from the sensor, the other vehicle is traveling in a second lane adjacent to a first lane that is the lane of the own vehicle, an obstacle located in front of the other vehicle in the second lane is detected, and the lateral velocity of the other vehicle, which is moving towards the first lane as it approaches the obstacle, from the second lane towards the first lane is decreasing.
